(19) United States
(12) Patent Application Publication
(10) Pub. No.: US 2022/0353241 A1
(43) Pub. Date: Nov. 3, 2022

(54) POLICY COMPILATION AND DISSEMINATION AS A LAYER 7 FIREWALL

(71) Applicant: AtScale, Inc., San Mateo, CA (US)

(72) Inventors: Jason L. Shiffer, Wilmot, NH (US); Kaushik Shanadi, Washington, DC (US); Dustin W. Webber, Dorchester, MA (US); Patrick J. Toole, Wellington, FL (US)

(21) Appl. No.: 17/733,017

(22) Filed: Apr. 29, 2022

Related U.S. Application Data
(60) Provisional application No. 63/182,917, filed on May 1, 2021.

(51) Int. Cl. H04L 9/40

(52) U.S. Cl. CPC H04L 63/0236; H04L 63/0263; H04L 63/20

(57) ABSTRACT

An embedded policy takes the form of an executable entity local to the endpoint or end application attempting to access target data. The executable entity is compiled from a declarative remote policy based on objects, subjects and actions, and includes a library and API (Application Programming Interface) in conjunction with a client application seeking access according to the policy. Evaluation of appropriate access is resolved with a local function call to the executable entity, rather than a network message exchange, thus providing data target access according to the policy without incurring network latency.

### RELATED APPLICATIONS

This patent application claims the benefit under 35 U.S.C. § 119(e) of U.S. Provisional Patent App. No. 63/182,917, filed May 1, 2021, entitled “POLICY COMPILATION AND DISSEMINATION AS A LAYER 7 FIREWALL,” incorporated herein by reference in entirety.

### BACKGROUND

Electronic databases store tremendous amounts of data, and have been doing so for several decades ever since the cost of computer hardware came within reach for most businesses and consumers. Large “data warehouses” now store vast amounts of data stored and are indexed according to a storage format, often according to tables or multidimensional arrangements, and indices that allow access to the data though interfaces and software defined by the particular vendor. Multidimensional databases extend the notion of conventional tabular data by allowing an arbitrary number of dimensions to be associated with each data item. This often takes the form of a number of data tables—two dimensional storage arrangements—arranged as a set of dimension and fact tables, possibly stored in different physical storage volumes or locations, in a logical arrangement referred to as a datacube.

### SUMMARY

An embedded policy takes the form of an executable entity local to the endpoint or end application attempting to access target data. The executable entity is compiled from a declarative remote policy based on objects, subjects and actions, and includes a library and API (Application Programming Interface) in conjunction with a client application seeking access according to the policy. Evaluation of appropriate access is resolved with a local function call to the executable entity, rather than a network message exchange, thus providing data target access according to the policy without incurring network latency.

Configurations herein are based, in part, on the observation that policy enforcement in access based systems becomes increasingly important when one or more data targets serves many users and the access afforded to each user may differ. Unfortunately, conventional approaches to coordinated access control suffers from the shortcoming that they do not provide a way to create declarative policies for queries and a means to enforce the policy. Accordingly, configurations herein substantially overcome the above-described shortcomings by creation of declarative policies which are then compiled into executable code for enforcement. The resulting executable code is provided as a proxy or embedded in the application for providing an executable entity that performs specific policy access evaluations based on a highly granular consideration of actors, assets and actions taken and returns quick authorizations through embedded library calls or invocations that do not incur a network exchange.

### BRIEF DESCRIPTION OF THE DRAWINGS

The foregoing and other objects, features and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a context diagram of a data target environment suitable for configurations herein.

FIG. 2 is block diagram of an embedded executable entity in the environment of FIG. 1;

FIG. 3 is a data and logic flow depicting policy enforcement as in FIG. 2; and

FIG. 4 is an example network implementation of the embedded executable entity.

### DETAILED DESCRIPTION

Various configurations depicting the above features and benefits as disclosed herein are shown and described further below. Configurations disclosed herein allow embedded and distributed policy enforcement to extend to network endpoints, typically end users and applications accessing the data target. Access authorization occurs at the endpoint via an executable entity on the endpoint system (CPU, server, device) without imposing a barrage of network based exchanges for authorization.

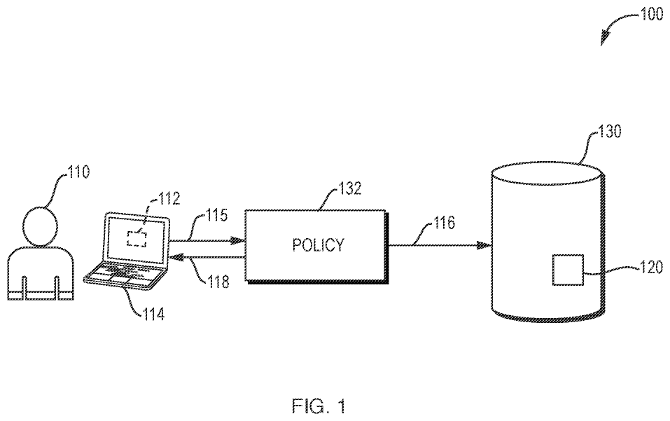

FIG. 1 is a context diagram of a data target environment suitable for configurations herein. Traditional data warehouse systems do not provide distributable access controls to allow/deny end users from retrieving stored data. Embodiments herein describe ways in which persons can control data access for a data target through policy enforcement. Referring to FIG. 1, in the data target environment 100, generally, a user 110, such as an employee, seeks some item of information 120 from a data target 130. The data target 130 has an authorization policy 132 (policy) which indicates who may access particular items in the data target 130. The user 110 invokes an application 112 on a computing device 114 for requesting the data item 120. The computing device 114 defines an endpoint, meaning a network terminus of the transmission path of the item of information, and the point at which it is disseminated to the user 112. Intermediate transmission points, such as routers, hubs and other network transmission devices merely pass the data item 120 through.

The policy 132 evaluates the request and allows the request to go through, shown by arrow 116, or denies the request and sends an indication 118 accordingly. The policy 132 may be regularly updated to reflect changes in actors (individuals, employees, groups, devices) and other entities that may access particular data target objects such as the data item 120, and may vary widely in complexity.

The data target 130 covered by the policy 132 includes any commonly located or distributed collection of data having a common thread, purpose, or ownership and designated for use by a designated user community. Such data target entities include any suitable entity or network location where structured data may be accessed, including databases, web pages, URL object, JSON (Javascript Object Notation) objects, data warehouses, disk farms, storage servers and the like responsive to the common policy (policy).

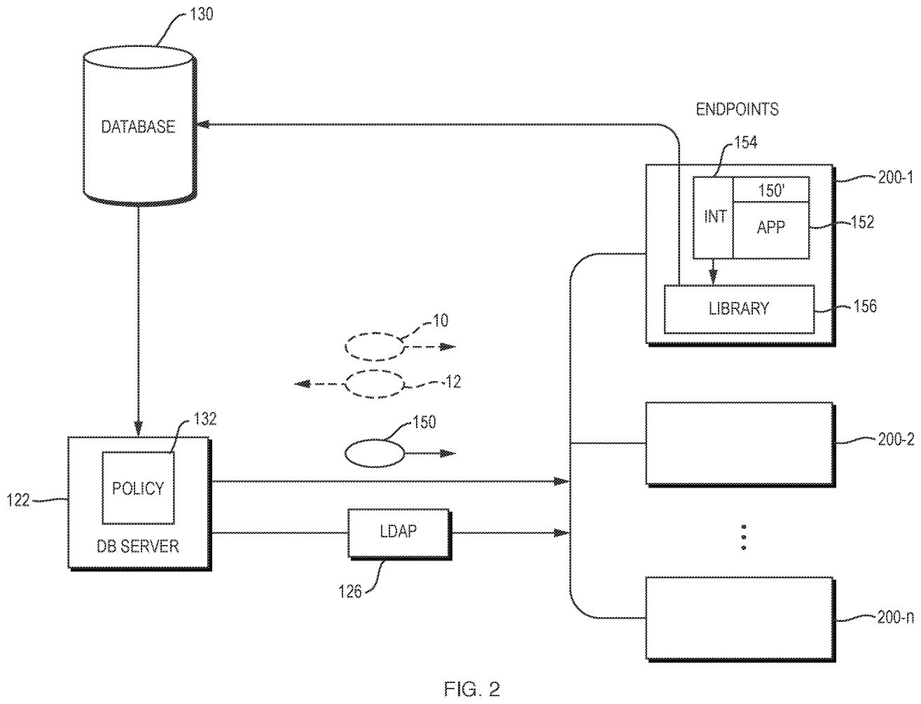

FIG. 2 is block diagram of an embedded executable entity in the environment of FIG. 1. Referring to FIGS. 1 and 2, the method for implementing the authorization policy 132 (policy) includes compiling an authorization policy into an executable entity 150. The policy 132 is a collection of declarative rules or statements that govern the behaviors of network devices, often in response to human actions. In a business enterprise, for example, network administrators define policies for network devices to follow to achieve business objectives. Most often, a primary consideration is protection of sensitive data. A policy server 122 distributes the executable entity 150 to a plurality of endpoints 200-1 . . . 200-3 (200 generally) of a network of users, and each endpoint 200 of the plurality of endpoints has a client application 152 responsive to the user 110. Each endpoint 200 is defined by a computing device 114 including memory and a processor operable for generating a access request 115. The endpoint 200 embeds the executable entity in the client application 152, such that the executable entity is responsive to access requests 115 from the client application.

The resulting embedded executable entity 154 is codified in executable code in the memory system on which the proxy or embedded application launches and executes. The embedded executable entity 150′ grants the access request 115 based on evaluation of the access request 115 against the authorization policy 132, such that evaluating is based only on instructions in the executable entity. Evaluating the access request 115 therefore occurs without network exchanges with the server 122 from which the authorization policy 132 emanated. In contrast, conventional approaches would require a network exchange including an authorization request message 10 and a corresponding response 12, both incurring a network latency. With a large number of queries/requests, such latency becomes untenable, particularly if there is a finer granularity in the authorization approach.

The executable entity 150 may be implemented as a library 156, having an API (Application Programming Interface) and invoked from API calls from the client application 152. The embedded executable entity then takes the form of an API interface 154 invoking the API in the library. The client application 152 is developed with exposure to the API such that the proper calls for policy authorization are embedded in the client application 152.

Updates and revisions to the policy, as well as initial distribution, are performed by storing the embedded executable policy 154 in the endpoint 200. The endpoint then links the library 156 with the client application 152 to resolve references (i.e. calls) to the API from the client application.

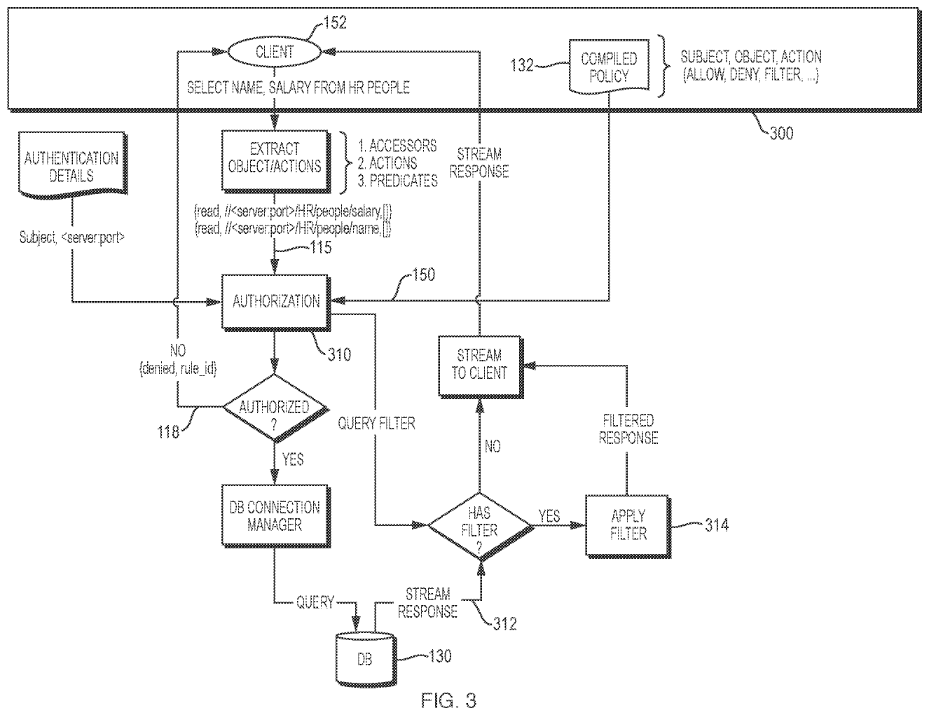

FIG. 3 is a data and logic flow depicting the enforcement of the policy compiled in FIG. 2. Embodiments herein describe ways in which administrators can create declarative policies and compile it into code for enforcement. Referring to FIGS. 1-3, declarative policies are compiled into the executable entity 150 for policy enforcement as in FIG. 2. As shown in FIG. 3, a policy and access control interface (UI+API) is used to manage declarative policies. An end user (DBA, Data Steward, Security teams) will use this interface to declare a policy based on a specific set of access control requirements. The executable entity 150, once launched, defines the enforcement engine and may be implemented by direct linking or a library implementation with the supported client application 152.

The method for enforcing an authorization policy therefore includes identifying an authorization policy 132 based on declarative designations of at least one of objects, assets and actions affected by an access request, and compiling the identified authorization policy into an executable entity 150.

Once the declarative policy 132 is created, it is then compiled and passed down 150′ to the embedded enforcement engine for providing authorization 310 of query requests 115.

The client applications 152 attach to one or more proxy connections which maintain backend data targets 130 using the enforcement engine. The client node 114 establishes a proxy connection from the client node to the data target 130, such that the proxy connection is responsive to the compiled executable entity 150 for enforcing the authorization policy. By running the executable entity on the node with the application 152, network exchanges for authorization are avoided. It follows that the access request 115 emanates from a client application 152 launched on the client node 114, and the client application is linked in a common address or library space with the executable entity 150.

When a query request is sent through the client, it is evaluated and the appropriate data needed to test authorization is extracted. Authorization is tested using the enforcement engine. This includes evaluating the database access request 115 by the executable entity 150 based on an extraction of objects, assets and actions referenced by the data target access request 115 against the authorization policy 132 for generating an authorization result for the query request. If the authorization fails 118, return an error to the client. If authorization is successful, the enforcement engine permits the database access request based on the authorization result, continues by passing the query to the data target. It also applies policy defined predicate logic on the query before passing the query and associating any return query filter logic with the streaming response for the query. This means that, for cases in which the query is not rejected outright but includes separable aspects that are disallowed, either the request or the result may be augmented and/or filtered to remove the offending data items while permitting the remainder of the query result.

The data target will execute the query and return data to the client via a streaming response 312. If any filters are applied before the query was sent to the data target, the filter logic 314 will be applied to the response data to filter/remove any unwanted or restricted data.

For example, a data steward does not want the development team to access any production data targets. Using the policy management engine, the data steward can define a policy to deny all authorization requests for users in the “developer” group on all production data targets (using a “*” catch all).

Once the policy is declared, the data steward can compile and deploy the policy to the enforcement engine. When any user who belongs to the developer group attempts to run queries against any production dataset, the user will see a rejection along with the reasons for rejection.

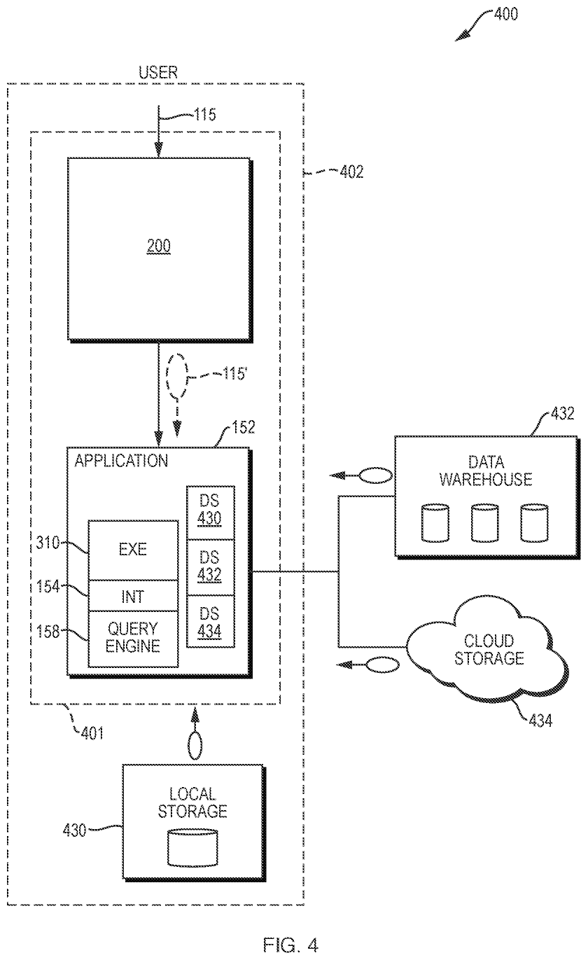

FIG. 4 is an example network implementation of the embedded executable entity; the configuration depicted in FIG. 4 is illustrative, and other configurations may of course invoke and benefit from the disclosed executable entity for determining and enforcing policy 132 decisions based on layer 7 interactions. Referring to FIGS. 1-4, in a query environment 400, the endpoint 200 defines the client receiving the user request 115. The user request 115 emanates from a network interconnecting separate computers and computing or network entities such as routers and hubs. Conventional approaches implement the authorization policy 132 by establishing security at a network level, either involving network exchanges or by imposing firewalls, filters and routing tables at intermediate network points to safeguard important data items and prevent unauthorized access. This results in computationally expensive network exchanges each time a request is made to access a data item.

It may be recognized that modern computing infrastructure can tend to blur the distinction between network transactions and instruction execution in volatile memory, traditionally referred to as RAM (Random Access Memory) or main memory. Modern computer architectures, with CPU clusters and parallel processing, incorporate a so-called bus between the processors and memory. While modern network and routing can rival the performance of older bus structures in computer architecture, there remains an identifiable distinction between operations based on CPU instructions occurring in an addressable memory space, and an I/O request that invokes a network request relying on the 7 layer stack. The former does not incur beyond the application layer (7), while the latter traverses the stack. By performing authorization checks in an executable entity, network bound authorization exchanges are avoided, which can be substantial with a large data set.

Computer networks rely on a so-called “7 layer” model, or stack, which has been the basis for network based interconnections for decades. The 7 layers define successive abstractions and repackaging of transmitted data, from the physical network transport (layer 1) to the application layer (layer 7) where software applications access and operate on the data. Conventional approaches to data security rely on outright network exchanges, traversing layers 1-7, or at some intermediate layer in a router, routing table, or firewall, for example. Conventional approaches do not establish a policy or access control using only layer 7 (application layer) capabilities. In contrast, the approach herein implements the authorization policy 132 at the application layer, without invoking a network exchange to transmit authorization requests. This provides that the policy 132, meaning access control to the database 130, is effectively handled by an executable entity (program) launched within the address space of the receiving computer. Hence, no network latency for performing a network transaction, and hence no traversal of the 7 layer stack, is incurred. In a particular configuration, code signing of the client application 152, or a related executable entity 150′ in the same address space, may be employed to provide the executable entity with sufficient “trust” to administer policy decisions.

In FIG. 4, the endpoint 200 defines the receipt of the user request 115, and the application 152 executes the query, typically within an address space 401 supporting executable entities. The address space 401 may be a single machine, or may be a cluster of machine having common memory access via shared memory or other access mediums. A network boundary 402 identifies transactions or exchanges that may occur without network messages or usage, and includes a local storage volume 430 of the address space 401. The example depicts the endpoint 200 and application 152 as separate processes within the address space, however these may be arranged in any suitable manner within the address space 401.

Data sets include 430, in local storage, 432, stored in a remote data warehouse, and 434, in a cloud storage via the Internet. Physical arrangement of the data is generally transparent, with the recognition that data sets 432 and 434 are outside the network boundary 204. The access request 115′ specifies one or more target data items; in this case it seeks data items in data sets 430, 432 and 434.

The policy 132 is launched or instantiated as authorizer 310, implemented as an executable entity 152′ and accessible via interface 154 from application 152. Application 152 may be operating as a query engine for accessing data sets 430, 432 and 434 for fulfilling the access request 115′. The authorization policy 132 includes a list of entities having access to the network, and defines one or more entries indicating data items and the conditions for which access is granted by the entity to the data items in the entry. The policy 132 is often specified as a list of conditional statements, and may have varying degrees of granularity. The set of entities includes at least one of network objects, subjects and entities and the entries are declarative designations define a conditional access statement to a stored data item. Entities may be users, machine names, IP addresses or other discreet identifier in the context of the network.

The application 152 receives the access request 115′ over a network, where the network relies on a plurality of network layers, as with most Internet conversant networks. The access request 115′ calls for data items from data sets 430, 432 and 434. The application 152 includes or invokes a query engine 158, which accesses interface 154 to the authorization executable 310. Note that this exchange occurs in the address space 401, either via linked or shared memory processes or libraries, interprocess communication, or other exchange that may be satisfied within the address space 401. This means the access request is evaluated based on machine instructions in the executable entity, and with an omission of network exchanges, so that network latency is not imposed. The query engine 158 evaluates the access request based on application layer exchanges with the executable entity (authorizer 310) and retrieves one or more data items DS430, DS432 and DS434 for satisfying the access request via the network. It should be noted that DS432 and DS434 are retrieved via network exchanges, although authorization to access was given by the authorizer. Additional security is likely established for the transmissions, proxy logins and other access steps for accessing the data sets 432 and 434, although the accessing entity, application 152, has been approved.

In an example configuration, integrity of the authorizer 310 is ensured by signing the executable entity for establishing authentication for access to the data target. This permits access to the data target based on a positive authorization result by the executable entity, such that the executable entity performs only layer 7 inquires for evaluation of the access request.

Those skilled in the art should readily appreciate that the programs and methods defined herein are deliverable to a user processing and rendering device in many forms, including but not limited to a) information permanently stored on non-writeable storage media such as ROM devices, b) information alterably stored on writeable non-transitory storage media such as solid state drives (SSDs) and media, flash drives, floppy disks, magnetic tapes, CDs, RAM devices, and other magnetic and optical media, or c) information conveyed to a computer through communication media, as in an electronic network such as the Internet or telephone modem lines. The operations and methods may be implemented in a software executable object or as a set of encoded instructions for execution by a processor responsive to the instructions, including virtual machines and hypervisor controlled execution environments. Alternatively, the operations and methods disclosed herein may be embodied in whole or in part using hardware components, such as Application Specific Integrated Circuits (ASICs), Field Programmable Gate Arrays (FPGAs), state machines, controllers or other hardware components or devices, or a combination of hardware, software, and firmware components.

While the system and methods defined herein have been particularly shown and described with references to embodiments thereof, it will be understood by those skilled in the art that various changes in form and details may be made therein without departing from the scope of the invention encompassed by the appended claims.

What is claimed is:

1. A method for enforcing an authorization policy, comprising:
identifying an authorization policy based on declarative designations of a set of entities affected by an access request;
compiling the identified authorization policy into an executable entity;
establishing a connection from a client node to a data target, the connection responsive to the compiled executable entity for enforcing the authorization policy;
evaluating the access request by the executable entity based on an extraction of objects, subjects and actions referenced by the access request against the authorization policy for generating an authorization result for the access request; and
permitting the access request based on the authorization result.

2. The method of claim 1 wherein the executable entity runs on the client node.

3. The method of claim 2 wherein the access request emanates from a client application launched on the client node, the client application linked in a common address space with the executable entity.

4. The method of claim 1 wherein the set of entities includes at least one of network objects, subjects and entities and the declarative designations define a conditional access statement to a stored data item.

5. The method of claim 1 wherein the authorization policy includes a list of entities having access to the network, and for each entity in the list of entities defining one or more entries indicating data items and the conditions for which access is granted by the entity to the data items in the entry.

6. The method of claim 1 further comprising:
signing the executable entity for establishing authentication for access to the data target; and
permitting access to the data target based on a positive authorization result by the executable entity, the executable entity performing only layer 7 inquires for evaluation of the access request.

7. The method of claim 6 further comprising evaluating the access request based on machine instructions in the executable entity and an omission of network exchanges for determining the authorization policy to be enforced by the executable entity.

8. The method of claim 1 further comprising:
receiving the access request over a network, the network relying on a plurality of network layers;
evaluating the access request based on application layer exchanges with the executable entity; and
retrieving one or more data items for satisfying the access request via the network.

9. A network device for fulfilling query requests based on an authorization policy, comprising:
a computer having a processor and a memory space;
an interface to a public access network for receiving access requests;
an authorization policy based on declarative designations of a set of entities affected by an access request;
an executable entity defining the authorization policy and stored in the memory space
an interface to a data target, the data target interface responsive to the compiled executable entity for enforcing the authorization policy;
the executable entity configured to:
determining an authorization result based on an extraction of objects, subjects and actions referenced by the access request against the authorization policy for generating an authorization result for the access request; and
permitting the access request to the data target based on the authorization result.

10. The device of claim 9 wherein the access request emanates from a client application, the client application linked in a common address space with the executable entity.

11. The device of claim 9 wherein the set of entities includes at least one of network objects, subjects and entities and the declarative designations define a conditional access statement to a stored data item.

12. The device of claim 9 wherein the authorization policy includes a list of entities having access to the network, and each entity in the list of entities defines one or more entries indicating data items and the conditions for which access is granted by the entity to the data items in the entry.

13. The device of claim 9 further comprising:
a signed executable entity for establishing authentication for access to the data target, the data target interface responsive to the signed executable entity for permitting access to the data target based on a positive authorization result by the executable entity, the executable entity configured for only layer 7 inquires for evaluation of the access request.

14. The device of claim 13 wherein the executable entity is configured to evaluate the access request based on machine instructions in the executable entity and an omission of network exchanges for determining the authorization policy to be enforced by the executable entity.

15. The device of claim 9 wherein:
the network interface connects to a network relying on a plurality of network layers and the executable entity is configured to evaluate the access request based on application layer exchanges with the executable entity,
the memory space configured to store one or more data items for satisfying the access request via the network.

16. A method for enforcing an authorization policy, comprising:
identifying an authorization policy based on declarative designations of a set of objects, subjects and actions affected by an access request;
compiling the identified authorization policy into an executable entity;
establishing a proxy connection from a client node to a data target, the proxy connection responsive to the compiled executable entity for enforcing the authorization policy;
evaluating the access request by the executable entity based on an extraction of objects, subjects and actions referenced by the access request against the authorization policy for generating an authorization result for the access request; and
permitting the access request based on the authorization result.

17. The method of claim 16 wherein the executable entity runs on the client node.

18. The method of claim 17 wherein the access request emanates from a client application launched on the client node, the client application linked in a common address space with the executable entity.
